(19) United States
(12) Patent Application Publication
(10) Pub. No.: US 2014/0065359 A1
(43) Pub. Date: Mar. 6, 2014

(54) GRAPHENE RIBBONS AND METHODS FOR THEIR PREPARATION AND USE

(71) Applicants: Giridhar UDAPI ROA KULKARNI, Bangalore (IN); Narendra KURRA, Guntur (IN); Abhay Abhimanyu SAGADE, Solapur (IN)

(72) Inventors: Giridhar UDAPI ROA KULKARNI, Bangalore (IN); Narendra KURRA, Guntur (IN); Abhay Abhimanyu SAGADE, Solapur (IN)

(73) Assignee: Jawaharial Nehru Centre for Advanced Scientific Researc, Bangalore (IN)

(21) Appl. No.: 13/599,810

(22) Filed: Aug. 30, 2012

(51) Int. Cl. B32B 3/10; B23K 26/36; B29C 59/16; B32B 37/02; B82Y 40/00; B82Y 30/00

(52) U.S. Cl. 428/141; 264/400; 156/236; 425/174.4; 219/121.69; 428/195.1; 977/734; 977/844; 977/932

(57) ABSTRACT

Methods of forming a pattern on a substrate are provided. The methods include providing a substrate and radiating a laser beam through a transmitting phase mask on the substrate. The transmitting phase mask includes a pattern and radiating the laser beam through the transmitting phase mask forms the pattern on a first surface of the substrate.

### BACKGROUND

Graphene, a two-dimensional carbon allotrope and a zero band gap semi metal, has attracted much attention in recent years due to its remarkable physical properties, including high thermal conductivity and electrical properties such as quantum Hall effect and ambipolar electric field. Several attempts have been made to isolate graphene sheets from graphite bulk crystals using techniques such as micro-mechanical cleavage, chemical exfoliation, liquid-phase exfoliation and growth using chemical vapor deposition. For example, micro-mechanical cleavage has been used to separate layers of graphene from highly oriented pyrolytic graphite (HOPG). Ribbons and terraces have been obtained by peeling off the surface layers of HOPG using scotch tape. However, most of these techniques produce randomly distributed graphene sheets on a given substrate and locating them for device fabrication can be very cumbersome.

In order to exercise a control over site-specific placement of graphene, certain techniques such as transfer printing, electrostatic exfoliation and site specific stamping of patterned graphite have been used. Moreover, photolithography and reactive ion etching techniques, involving multiple processing steps have also been used for patterning HOPG. Most of these techniques are tedious, time consuming and are substantially expensive.

### SUMMARY

The foregoing summary is illustrative only and is not intended to be in any way limiting. In addition to the illustrative aspects, embodiments, and features described above, further aspects, embodiments, and features will become apparent by reference to the drawings and the following detailed description.

Briefly, in accordance with one aspect, methods of forming a pattern on a substrate are provided. The methods include providing a substrate and radiating a laser beam through a transmitting phase mask on the substrate. The transmitting phase mask includes a pattern and radiating the laser beam through the transmitting phase mask forms the pattern on a first surface of the substrate.

In accordance with another aspect, methods of forming a pattern on a substrate are provided. The methods include providing a highly oriented pyrolytic graphite (HOPG) substrate and radiating a laser beam through a transmitting phase mask on the HOPG substrate. The transmitting phase mask includes a pattern and radiating the laser beam through the transmitting phase mask forms a graphene pattern on a first surface of the HOPG substrate. The methods include disposing a transferring agent on the first surface of the HOPG substrate such that the transferring agent covers the graphene pattern and removing the transferring agent with the attached graphene pattern from the HOPG substrate. The methods also include transferring the graphene pattern from the transferring agent to a second substrate using a solvent.

In accordance with another aspect, graphene devices are provided. The graphene device can include a plurality of graphene features having a pre-determined shape and arranged in a pattern. An edge roughness of the graphene features can be less than about 1 nanometer (nm).

In accordance with another aspect, systems for forming a pattern on a substrate are provided. The systems can include a laser source and a transmitting phase mask having a pattern. The laser source can be configured to apply a periodically modulated laser beam through the transmitting phase mask on the substrate to form the pattern on the substrate.

### BRIEF DESCRIPTION OF THE FIGURES

FIG. 1 is an example flow diagram of an embodiment of a method of forming a pattern on a substrate.

FIG. 2 illustrates an example system used for forming a pattern of graphene features on a HOPG substrate.

FIG. 3 illustrates side views of a HOPG substrate and a grating pattern formed on the substrate using the system of FIG. 2.

FIG. 4 is an example atomic force microscopy (AFM) topography image of a grating pattern formed on a HOPG substrate.

FIG. 5 illustrates example AFM height profiles of a phase mask and the grating pattern formed on the HOPG substrate of FIG. 2 along with periodic variation in laser intensity.

FIG. 6 is an example scanning electron microscope (SEM) image of the grating pattern formed on the HOPG substrate of FIG. 2.

FIG. 7 is a graphical representation of laser fluence vs. a depth of the grating pattern formed on the HOPG substrate.

FIG. 8 illustrates an example process used for transferring graphene ribbons from the HOPG substrate of FIG. 2 onto another substrate.

FIG. 9 is an optical image of the graphene ribbons formed on the surface of a transferring agent.

FIG. 10 is an optical image of graphene ribbons transferred onto a silicon substrate.

FIG. 11 is an example AFM image of graphene ribbons transferred onto the silicon substrate.

FIG. 12 is a histogram of example thickness distribution of the graphene ribbons transferred onto the silicon substrate.

FIG. 13 is an example Raman spectra for the HOPG substrate, the grating pattern formed on the HOPG substrate and transferred graphene ribbons.

FIG. 14 is an example field emission scanning electron microscopy (FESEM) image of a single graphene ribbon across gold (Au) contacts on a silicon substrate.

FIG. 15 is a graphical representation of current-voltage characteristics of the graphene ribbon of FIG. 14.

FIG. 16 is an example AFM topography image of multi-layer graphene ribbons (MLGRs) disposed on the HOPG substrate.

FIG. 17 illustrates example I-V curves for the MLGRs disposed on a HOPG substrate.

FIG. 18 illustrates example AFM topography images of graphene ribbons with varying thicknesses.

FIG. 19 illustrates example Raman spectra of the few-layered ribbons of FIG. 18.

FIG. 20 is an example AFM image of a single graphene ribbon formed using the system of FIG. 2.

FIG. 21 is an example AFM image of graphene ribbons transferred using PDMS.

FIG. 22 illustrates example AFM images of various geometric patterns formed using the system of FIG. 2.

FIG. 23 is an example image of an example pattern formed on the HOPG substrate using a DVD as the transmitting phase mask.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

It will also be understood that any compound, material or substance which is expressly or implicitly disclosed in the specification and/or recited in a claim as belonging to a group or structurally, compositionally and/or functionally related compounds, materials or substances, includes individual representatives of the group and all combinations thereof. While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

Example embodiments are generally directed to a technique of forming patterns on substrates such as highly oriented pyrolytic graphite (HOPG) substrates. The present technique uses periodic laser ablation of the substrate in presence of one or more transmitting diffraction gratings to form a desired pattern on the substrate. The technique may be used for large-area direct patterning without the need of resists for forming patterns on substrates. The disclosed technique uses single laser pulses applied through the transmitting diffraction gratings thereby enabling usage of the gratings multiple times.

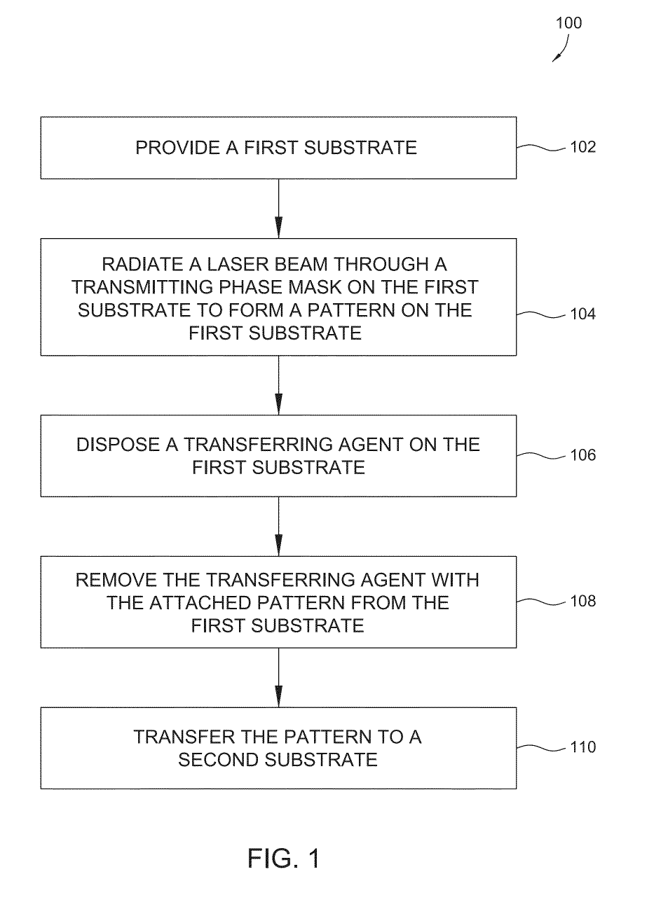

Referring now to FIG. 1, an example flow diagram 100 of an embodiment of a method of forming a pattern on a substrate is illustrated. At block 102, a first substrate is provided. The first substrate may include a polymer, a metal, a semiconductor, an insulating material, or combinations thereof. A laser beam is radiated through a transmitting phase mask on the first substrate (block 104). The transmitting phase mask includes a pattern and radiating the laser beam through the transmitting phase mask forms the pattern on a first surface of the first substrate. In this example embodiment, a single shot of laser pulse is applied through the transmitting phase mask to form the pattern on the first substrate.

In certain embodiments, the laser beam is radiated through a second mask on the substrate. Here, the second mask comprises a second pattern and radiating the laser beam through the second mask forms the second pattern on the first surface of the substrate. The second mask may include a transmitting phase mask, a shadow mask, or combinations thereof.

In one example embodiment, the first substrate includes a HOPG substrate and the pattern includes a graphene pattern. For example, the pattern may include a periodic array of lines patterned on the HOPG substrate by spatially modulating the laser intensity through the transmitting phase mask. The patterned surface may serve as a source of multi and few layer graphene ribbons for transfer onto desired substrates as will be described below. The transmitting phase mask may include a compact disk (CD), a digital video disk (DVD), or combinations thereof. The pattern formed on the first substrate may be transferred to any other suitable substrate. At block 106, a transferring agent is disposed on the first surface of the first substrate such that the transferring agent covers the pattern. Examples of the transferring agent include, but are not limited to, polydimethylsiloxane (PDMS), polymethyl methacrylate (PMMA), or combinations thereof. The transferring agent may be subsequently cured.

Further, the transferring agent along with the attached pattern is removed from the first surface of the first substrate (block 108). At block 110, the pattern is transferred to a second substrate using a solvent. The second substrate may be silicon, silicon dioxide, glass, or combinations thereof. Examples of the solvent include toluene, chloroform, diisopropylamine, triethylamine, tetrahydrofuran (THF), pentane, ether, or combinations thereof. The solvent is dispensed onto the transferring agent to release the pattern from the transferring agent. The transferring agent is subsequently removed from the second substrate and the second substrate is heated to remove any residual solvent.

A graphene device including a plurality of graphene features may be formed using the process 100 described with reference to FIG. 1. The graphene features may have a pre-determined shape and arranged in a desired pattern. In one example embodiment, the graphene features include graphene ribbons. In another embodiment, the graphene features include graphene-oxide ribbons. In one embodiment, the graphene features formed using the process described above have substantially smooth edges. In certain example embodiments, an edge roughness of the graphene features is less than about 1 nanometer (nm). In other embodiments, the edge roughness of the graphene features is about 0.6 nm to about 0.8 nm. The graphene features may be single-layered features, multi-layer features, or combinations thereof. The graphene device formed using the process of FIG. 1 may be used as a transparent conducting electrode for use in solar cells.

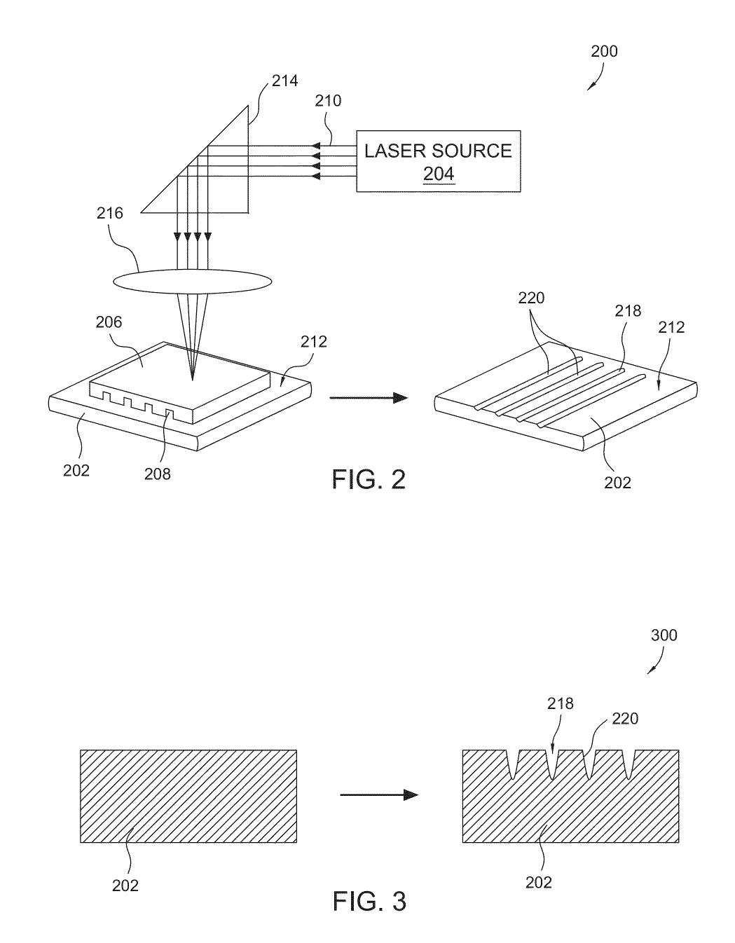

FIG. 2 illustrates an example system 200 used for forming a pattern on a substrate 202. The substrate 202 may include polymer, a metal, a semiconductor, an insulating material, or combinations thereof. In one example embodiment, the substrate 202 includes a HOPG substrate. The system 200 includes a laser source 204 and a transmitting phase mask 206 having a pattern 208. The laser source 204 is configured to apply a periodically modulated laser beam 210 through the transmitting phase mask 206 on a first surface 212 of the substrate 202. In one example embodiment, the laser source 204 includes a Nd:YAG laser. However, other suitable laser sources may be used.

The transmitting phase mask 206 may include compact disk (CD), a digital video disk (DVD), or combinations thereof. The transmitting phase mask 206 may include a desired pattern that is transferred to the substrate 202 on applying the laser beam 210 through the transmitting phase mask 206. The transmitting phase mask 206 can generally be of any size. In certain embodiments, the size of the transmitting phase mask 206 may be selected based upon the size of the substrate 202 and a type of the pattern 208 to be formed on the substrate 202. In one embodiment, the pattern 208 includes an array of parallel lines. A variety of other patterns with different shapes and sizes may be envisaged. For example, the pattern 208 may include check-board pattern, diamond pits, among others. The transmitting phase mask 206 is placed in contact with the substrate 202.

The system 200 may include other components to focus the laser beam 210 onto the substrate 202. In the illustrated embodiment, the system 200 includes a total internal reflection (TIR) prism 214 and a lens 216 used to focus the laser beam 210 onto the first surface 212 of the HOPG substrate 202. The laser source 204 is operated in a Q-switch mode to apply a single shot of laser pulse on the substrate 202 under ambient conditions. As the laser beam 210 is applied through the phase mask 206 onto the substrate 202, a pattern 218 (corresponding to the pattern 208 of the transmitting phase mask 206) is formed on the first surface 212 of the substrate 202. Here, the periodic modulation of laser beam intensity in presence of the transmitting phase mask 206 ablates the material to produce the pattern 218 with features 220 on the substrate 202.

The pattern 218 formed on the substrate 202 may be transferred to any other suitable substrate using a transferring agent such as PDMS as described above with reference to FIG. 1. In certain embodiments, the pattern 218 may be transferred to another substrate using electrostatic transfer technique.

FIG. 3 illustrates side views 300 of an example substrate 202 and a grating pattern 218 formed on the substrate 202 using the system 200 of FIG. 2. In the illustrated embodiment, the substrate 202 includes a HOPG substrate and the pattern 208 includes an array of parallel lines. In this example embodiment, a single shot of laser pulse applied through the transmitting phase mask 206 to form the HOPG grating pattern 218 having parallel gratings/features 220 on the first surface 212 of the substrate 202. The size of the gratings/features 220 can generally be of any size depending upon the pattern 208 on the transmitting phase mask 206. As can be seen, the direct patterning technique using single-step near-field ablation resulted in the grating pattern 218 having gratings 220 corresponding to the pattern 208 on the transmitting phase mask 206. A variety of patterns/features having desired shapes and sizes may be formed in a similar manner.

EXAMPLES: The present invention will be described below in further detail with examples and comparative examples thereof, but it is noted that the present invention is by no means intended to be limited to these examples.

Example 1: Configuration of an example system for forming graphene features on a HOPG substrate. An example system 200 used for forming a pattern of graphene features on a HOPG substrate 202 included a Nd:YAG laser 204 (Quanta-Ray GCR-170, spectra-Physics, USA.) having a wavelength of about 355 nanometers (nm), energy of about 100 mJ/pulse, and with a pulse width of about 10 ns that was used in a single shot mode for ablation of HOPG substrate 202. The laser fluence of the laser 204 was varied from about 1.1 J cm⁻² to about 4.2 J cm⁻².

A compact disk (CD) was used as the transmitting phase mask 206. Such CDs are commercially available from companies such as Sony, India. The CD 206 was cleaned using isopropanol and ethanol solvents to remove the dye and the aluminum layer was peeled off from the surface of the CD 206 using tweezers. The size of the CD 206 was about 15×15 mm² having an array of parallel lines with a width of about 1 micrometer (μm), a spacing of about 500 nm, and a height of about 180 nm. The CD 206 was placed in contact with the HOPG substrate 202 without applying any additional pressure. It should be noted that the flat and smooth surface of the CD 206 enabled conformal contact of the CD 206 with the HOPG substrate 202.

The laser beam 210 was partially defocused towards the HOPG substrate using a 90° TIR prism 214 and a lens 216 with a focal length of 30 cm. The laser source 204 was operated in a Q-switch mode to apply a single shot of laser pulse on the HOPG substrate 202 under ambient conditions. The diameter of the partially defocused laser beam 210 was about 2 mm. As the laser beam 210 was applied through the CD 206 onto the HOPG substrate 202, the HOPG grating pattern 218 having parallel gratings/features 220 was formed on the first surface 212 of the substrate 202.

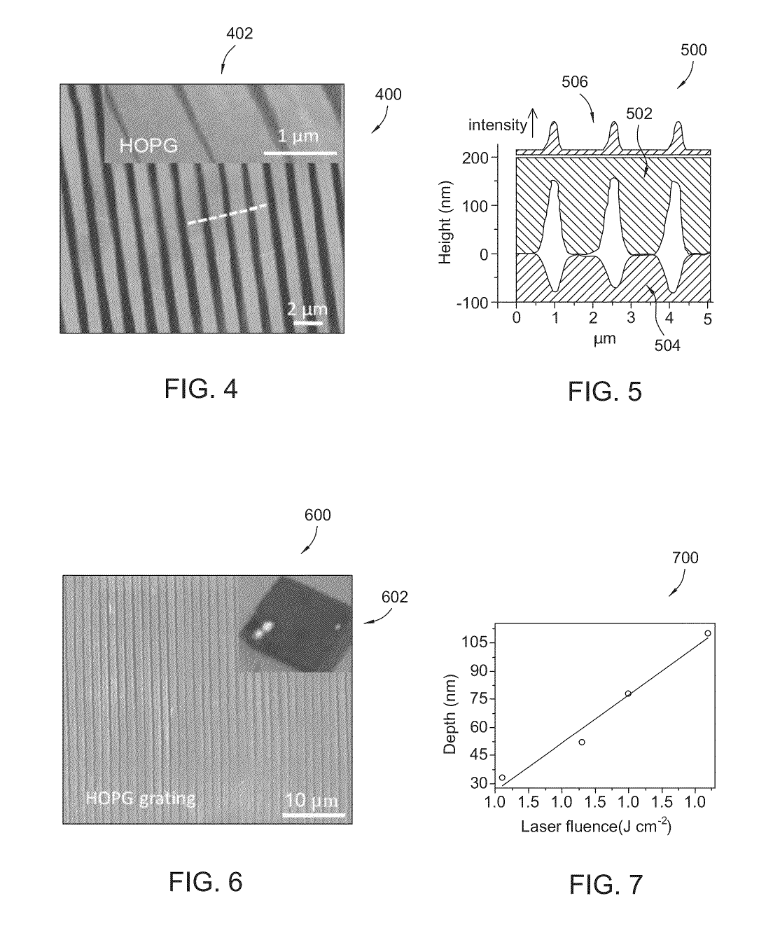

Example 2: Characterization of the HOPG grating pattern formed using the system of FIG. 2. FIG. 4 is an example atomic force microscopy (AFM) topography image 400 of the grating pattern 218 formed on the HOPG substrate 202 along with a magnified AFM image portion 402 showing the grating 220. AFM imaging was performed in contact mode on an Innova scanning probe microscope (SPM) (obtained from Veeco, USA) using Si probes (model, RTSPA) in contact mode. As can be seen from the AFM topography image 400, the substrate included a periodic line array having parallel stripes having a width of about 1.1 μm separated by a spacing of about 450 nm and a height of about 80 nm formed on the HOPG substrate. Here, the periodic unablated areas of the HOPG substrate 202 were substantially smooth as those regions were not affected during the laser irradiation.

FIG. 5 illustrates example AFM height profiles 500 of the phase mask (CD) 206 and the grating pattern 218 formed on the HOPG substrate 202 of FIG. 2. The profile of the CD phase mask 206 is represented by reference numeral 502 and the profile of the grating pattern 218 is represented by reference numeral 504. The periodic variation of the laser intensity of the laser source 204 is represented by profile 506. As can be seen from the profiles 502 and 504, the width of the grating pattern 218 formed on the substrate 202 is substantially the same as the relief feature in the phase mask 206. The width of the pattern was measured to be about 1100 nm. However, the depth of the features 220 was measured to be about 80 nm, in contrast to 180 nm in the phase mask 206. This indicated that the laser intensity was amplified through land regions of the HOPG substrate 202 thus causing periodic ablation of carbon.

FIG. 6 is an example scanning electron microscope (SEM) image 600 of the grating pattern 218 formed on the HOPG substrate 202 of FIG. 2. Here, inset 602 shows an optical micrograph of the grating pattern 218. The depth of laser ablation on the HOPG substrate 202 was controlled by adjusting the laser fluence. FIG. 7 is a graphical representation 700 of laser fluence vs. a depth of the grating pattern 218 formed on the HOPG substrate 202. As can be seen, the depth varied linearly at lower laser fluence. It should be noted that a depth of about 25 nm to about 30 nm of the pattern 218 was achieved using a Q-switch threshold fluence of about 1.1 J cm⁻², which was comparable to the skin depth of the HOPG substrate 202 of about 20 nm.

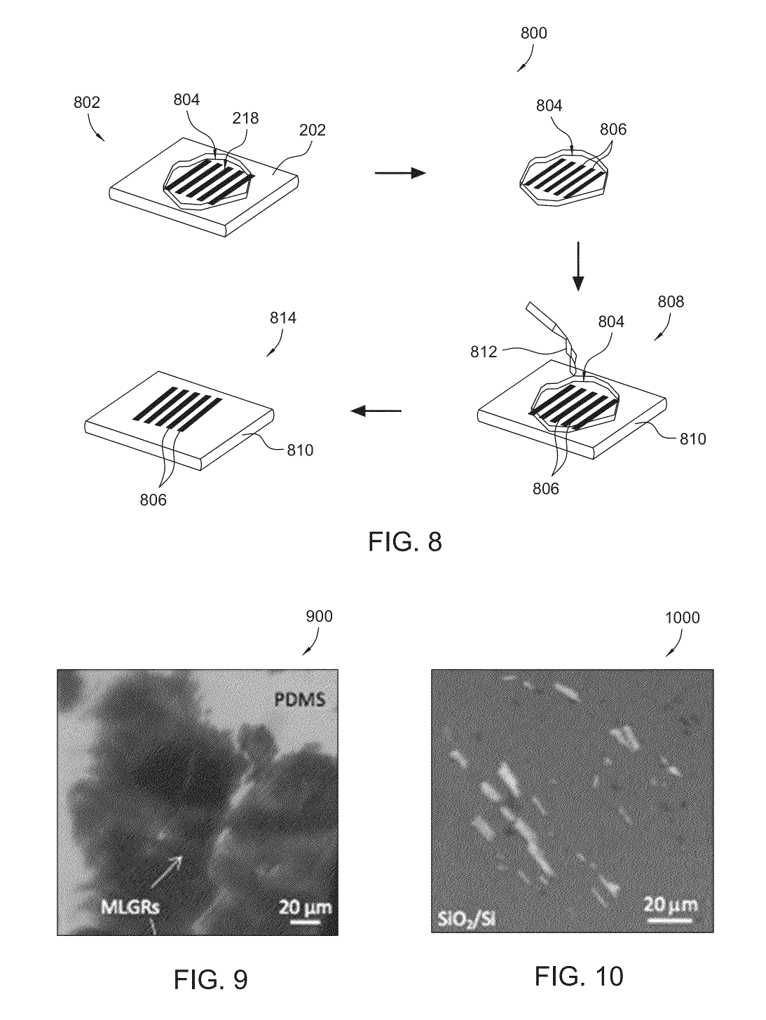

Example 3: Process for transferring graphene ribbons from the HOPG substrate onto a silicon dioxide/silicon substrate. FIG. 8 illustrates an example process 800 used for transferring graphene ribbons from the HOPG substrate 202 onto another substrate such as a silicon dioxide/silicon substrate. At step 802, polydimethylsiloxane (PDMS) 804 was drop coated on the first surface 212 of the HOPG substrate 202 such that the PDMS 804 covered the pattern 218. Here, the PDMS pre-polymer 804 was mixed with Sylgard 184 curing agent (obtained from Dow Corning) in the ratio of 1:5 by weight. The mixture was then degassed under vacuum for 30 minutes. The PDMS 804 was then subjected to curing at a temperature of about 60° C. The cured PDMS 804 along with the attached pattern 218 was then peeled from the HOPG substrate 202. The PDMS 804 surface included attached parallel sets of graphene ribbons 806 adhering to the surface.

At step 808, the peeled PDMS 804 carrying the ribbons 806 was placed on a silicon dioxide/silicon_substrate (SiO₂/Si) 810 while pouring few drops of toluene 812 under gentle pressure. The silicon dioxide/silicon substrate was cleaned by sonicating in acetone and isopropanol and was dried by blowing dry nitrogen. The solvent toluene 812 caused swelling of the PDMS 804 and released the graphene ribbons 806 from the PDMS 804. PDMS 804 was subsequently removed from the substrate 810 and the substrate 810 was heated to a temperature of about 130° C. to remove any residual toluene (step 814).

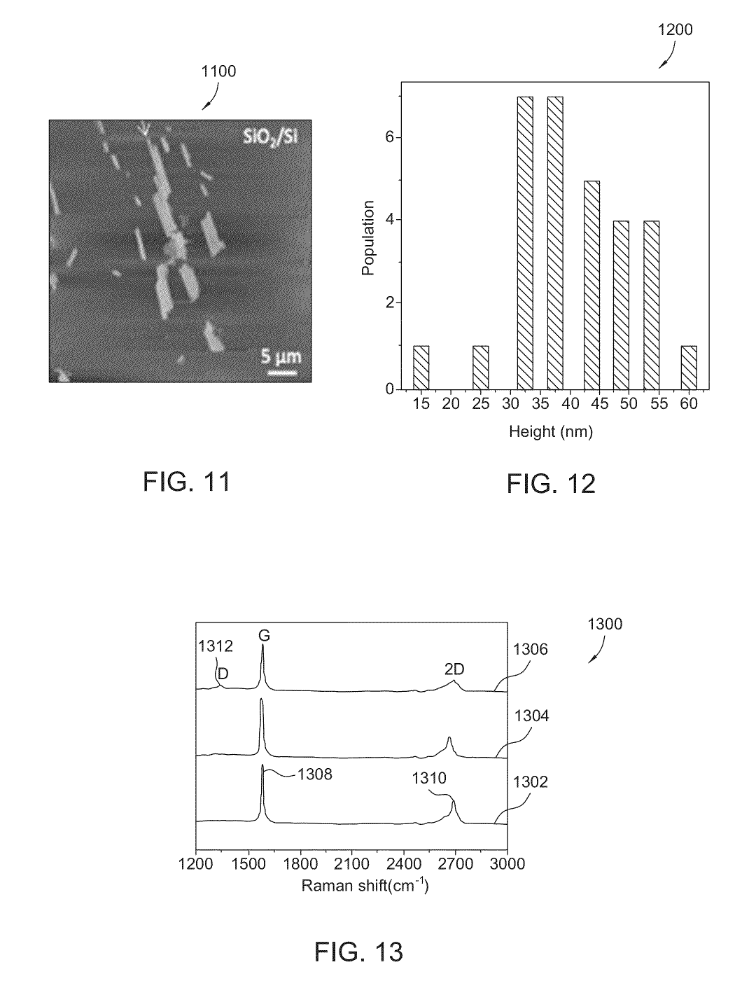

Example 4: Surface morphology of the PDMS and silicon substrate surfaces with the graphene ribbons. FIG. 9 is an optical image 900 of the graphene ribbons 806 formed on the surface of the cured PDMS 804. The graphene ribbons were examined using an optical microscope obtained from Laben, India. As can be seen, parallel sets of the ribbon-like structures are seen adhered to the surface of the PDMS 804. FIG. 10 is an optical image 1000 of the graphene ribbons 806 transferred onto a silicon dioxide/silicon substrate 810. Further, FIG. 11 is an AFM image 1100 of the graphene ribbons 806 transferred onto the silicon dioxide/silicon substrate 810. As can be seen from the images 1000 and 1100, several aligned graphene ribbons 806 were dispersed on the silicon dioxide/silicon substrate 810. FIG. 12 is a histogram 1200 of example thickness distribution of the graphene ribbons 806 transferred onto the silicon dioxide/silicon substrate 810. The thickness distribution estimated using AFM height profiles indicated that a majority of the graphene ribbons 806 had thicknesses in the range of about 30 nm to about 40 nm indicating that graphene ribbons were multi-layered hereinafter referred to as multi-layer graphene ribbons (MLGRs)”. The width of the MLGRs was measured to be about 1.1 μm.

Example 5: Characterization of MLGRs. Raman spectroscopy was used for structural characterization of the MLGRs 806. Raman spectroscopy measurements on the ribbons were carried out using a micro-Raman spectrometer (Model No. 25-LHR-151-230 obtained from Melles-Griot, USA) with an excitation wavelength of 632.8 nm and a laser spot size of 1 μm. FIG. 13 is an example Raman spectra 1300 for the HOPG substrate 202, the grating pattern 218 and the transferred MLGRs 806. The Raman spectra obtained for the HOPG substrate 202, the grating pattern 218 formed on the HOPG substrate 202 and the transferred MLGRs 806 on the silicon dioxide/silicon substrate 810 are represented by profiles 1302, 1304 and 1306 respectively. As can be seen, the Raman spectrum for the HOPG substrate 202 included two major peaks represented by reference numerals 1308 and 1310 at about 1580 cm⁻¹ (G-band) and about 2690 cm⁻¹ (2D band) respectively. The presence of G band was due to in plane vibrations of sp² carbon network and the presence of D band at 1330 cm⁻¹ was indicative of disorder such as topological or functional defects in the large sp² carbon network.

The Raman spectrum 1304 for the HOPG substrate 202 with the grating pattern 218 was observed to be similar to the spectrum 1302 for the substrate 202. This indicated that under single shot mild irradiation (with laser fluence of about 1.1 J cm⁻²), the pristine nature of graphite did not change. On the other hand, multiple laser shots (5-10) may cause structural modification of the HOPG substrate depending on the magnitude of laser fluence where the intensity of the D band is more than that of the G band, disrupting the c-axis periodicity.

As can be seen from Raman spectrum 1306, a small D band (represented by reference numeral 1312) was observed in the spectrum for MLGRs 806 owing to edge defects. It should be noted that the sp² crystallinity was preserved across the interior regions of the ribbons 806 as the edges were formed during the ablation process. Here, the transferring process using PDMS in presence of mild solvents also did not affect the crystallinity of the ribbons 806. Moreover, electron diffraction patterns collected at different locations on the graphene ribbons showed bright spots with hexagonal symmetry.

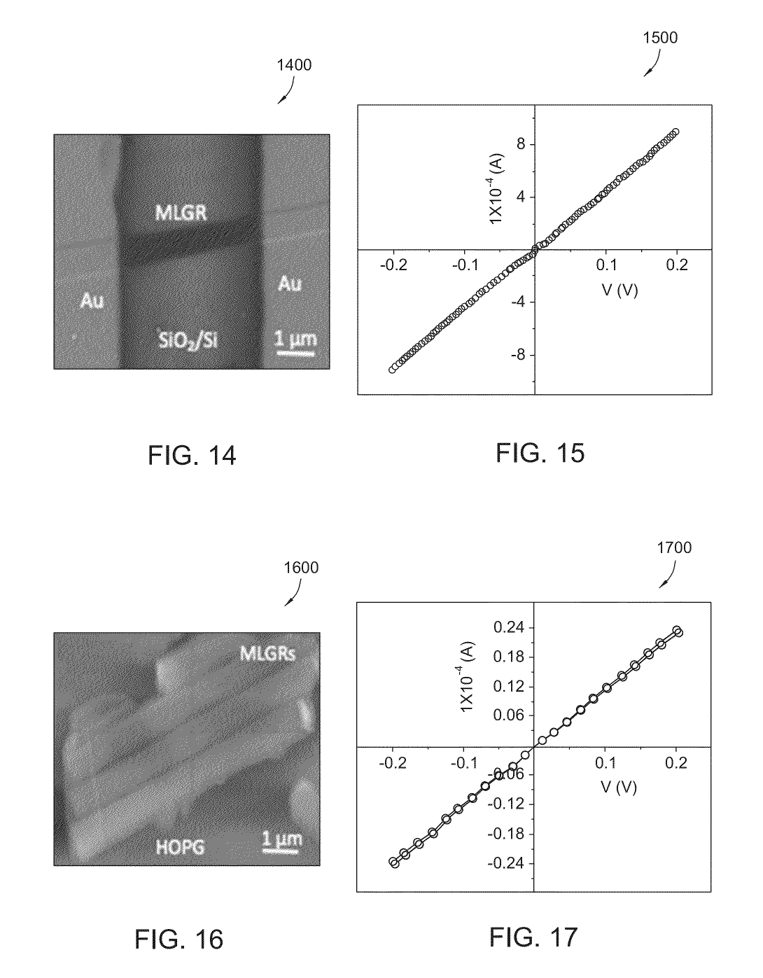

FIG. 14 is an example field emission scanning electron microscopy (FESEM) image 1400 of a single graphene ribbon 806 across gold (Au) contacts on the silicon dioxide/silicon substrate 710. Field emission scanning electron microscopy (FESEM) images were obtained using a Nova Nano SEM 600 instrument (obtained from FEI Co., Netherlands). FIG. 15 is a graphical representation of current-voltage characteristics 1500 of the graphene ribbon 806 of FIG. 14. An external multimeter (Keithley 236) served as the source and measurement unit for current-voltage characteristics of the graphene ribbon 806. The in-plane I-V characteristics were measured by placing a MLGR 806 having thickness of about 25 nm across Au gap electrodes on SiO₂/Si substrate 810. As can be seen from profile 1500, a linear behavior was observed with a resistance of about 1 kΩ, which also included the contact resistance from the gold-graphite interface.

Here, two probe measurements were also performed in the transverse direction (across the thickness of the MLGR 806). The MLGRs 806 from the PDMS 804 were transferred onto another HOPG substrate that served as a bottom electrode while a conducting atomic force microscopy tip was brought in contact as the top electrode. In order to minimize the contact resistance between the MLGR 806 and the HOPG substrate, the sample was heated to a temperature of about 200° C. for about 15 minutes, prior to conductive atomic force microscopy (CAFM) measurement.

FIG. 16 is an example AFM topography image 1600 of MLGRs 806 disposed on the HOPG substrate 202. The thickness, width and the length of the MLGRs 806 were about 30 nm, 3 μm and 12 μm respectively. A number of I-V curves were recorded for the MLGRs 806 disposed on the HOPG substrate 202 by placing a conducting tip at different locations on the surface of the MLGRs 806, as represented by profiles 1700 in FIG. 17. The average resistance of MLGRs 806 in the transverse geometry was measured to be about 23 kΩ. These observations indicated that the MLGRs 806 formed using the patterning process were well conducting and retained the graphitic properties.

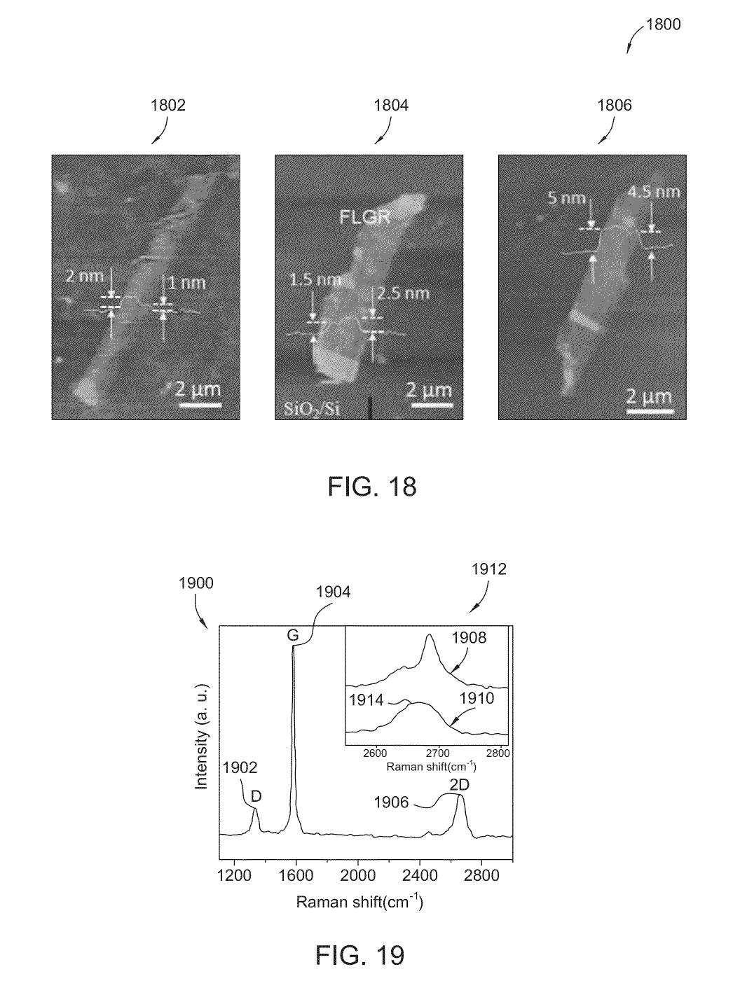

Example 6: Characterization of few layer graphene ribbons (FLGRs). By optimizing the transfer conditions of the process 800 of FIG. 8, relatively thin and FLGRs were obtained. FIG. 18 illustrates example AFM topography images 1800 of graphene ribbons with varying thicknesses. The images 1802, 1804 and 1806 are images showing graphene ribbons 806 having thicknesses of about 2 nm, about 2.5 nm and about 5 nm respectively. These relatively thin and few-layered ribbons 806 were formed by bringing the HOPG substrate 202 in contact with PDMS 804, while the latter was being cured at a temperature of about 120° C. thereby facilitating control of the adhesion of PDMS 804 with the HOPG substrate 202. The thickness of the graphene ribbons 806 was reduced while being on the PDMS surface 804 by repeated peel-off. Subsequently, the graphene ribbons 806 were transferred onto the SiO₂/Si substrate 810 by swelling the PDMS 804.

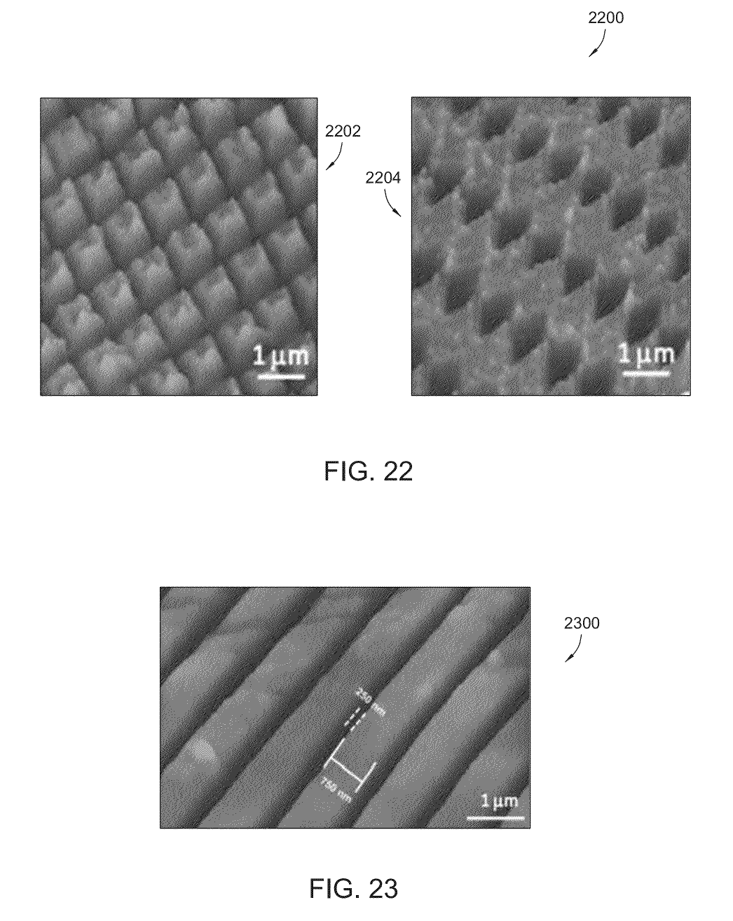

As can be seen from the AFM images 1800, the graphene ribbons 806 formed using the process described above were observed to be substantially thin and had a relatively less number of layers. For example, the thickness of the graphene ribbon 806 seen in the image 1804 was measured to be about 2 nm and included about 6 graphene layers. FIG. 19 illustrates example Raman spectra 1900 of the few-layered ribbons 806 of FIG. 18. As can be seen, the Raman spectrum 1900 corresponding to the 2 nm thick graphene ribbons 806 had a D band (1902) at about 1380 cm⁻¹, G band (1904) at about 1580 cm⁻¹ and 2D band (1906) at about 2685 cm⁻¹.

It should be noted that the 2D band (1906) reflects the electronic band structure of the graphene ribbons 806. Moreover, the shape and position of the 2D band (1906) is related to the number of graphene layers. The 2D bands of the HOPG substrate 202 and the graphene ribbons 806 are represented by reference numerals 1908 and 1910 in inset profiles 1912. As can be seen, the 2D band 1910 of the FLGRs included a broad single peak 1914 that is shifted with respect to the HOPG 2D band 1908, which is a signature of a 5-6 layered graphene.

Example 7: Roughness measurement of graphene ribbons formed using the system of FIG. 2. FIG. 20 is an example AFM image 2000 of a single graphene ribbon 806 formed using the system of FIG. 2. The arrows (represented by reference numeral 2002) are pointing towards an edge of the graphene ribbon. Here, the roughness of the edges of the graphene ribbon was measured to be about 0.4 nm indicating substantially smooth edge morphology.

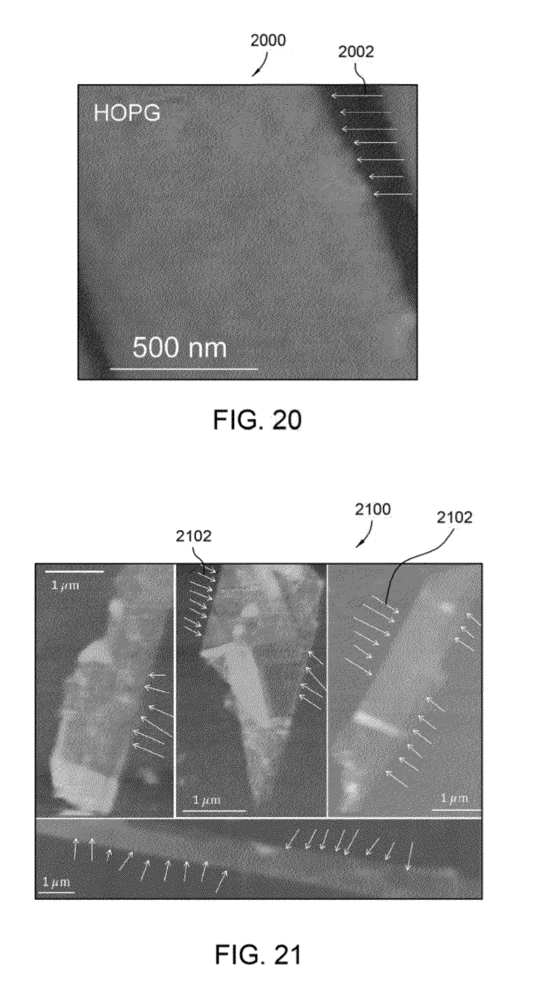

FIG. 21 is an example AFM image 2100 of graphene ribbons transferred using PDMS 804. As can be seen, edges of the few layer graphene ribbons are substantially smooth even after the transfer using the PDMS 207. The arrows (represented by reference numeral 2102) point towards edges of the graphene ribbons. The roughness of the edges of the graphene ribbons in the above image was measured to be about 0.6 to about 0.8 nm indicating that the transferred few layer graphene ribbons have substantially smooth edges.

Example 8: Geometric graphene patterns formed using the system of FIG. 2. The periodic laser ablation technique described above was used to pattern the HOPG substrate 202 with a variety of geometrical patterns using a combination of a shadow mask and a transmitting phase mask. AFM images 2200 of various geometric patterns formed using the present technique are shown in FIG. 22. A second laser shot on a HOPG grating hosting a phase mask with its features running perpendicular was used to produce a check board pattern on the HOPG substrate 202, as can be seen in image 2202. Similarly, an array of diamond like pits were patterned on the HOPG substrate 202 (image 2204) after irradiating a single laser pulse through a stack of two phase masks with their patterns aligned at an angle of about 30°.

The modulation of the laser intensity in a 2-dimensional manner was used to produce periodic array of holes whose shape depended on the orientation of the patterns of phase masks. It should be noted that other masks such as a digital videodisk (DVD) may be used as a transmitting phase mask to form a pattern on a substrate. FIG. 23 is an example image 2300 of an example pattern formed on the HOPG substrate 202 using a DVD as the transmitting phase mask. As can be seen, the patterned features formed using the DVD were substantially narrower in conformity with grating parameters of the phase mask.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc.

As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method of forming a pattern on a substrate, the method comprising:
providing a substrate;
radiating a laser beam through a transmitting phase mask on the substrate, wherein the transmitting phase mask comprises a pattern and radiating the laser beam through the transmitting phase mask forms the pattern on a first surface of the substrate.

2. The method of claim 1, wherein the substrate comprises a polymer, a metal, a semiconductor, an insulating material, or combinations thereof.

3. The method of claim 2, wherein the substrate comprises a highly oriented pyrolytic graphite (HOPG) substrate.

4. The method of claim 1, wherein radiating the laser beam comprises applying a single shot of laser pulse through the transmitting phase mask to form the pattern on the substrate.

5. The method of claim 1, further comprising radiating the laser beam through a second mask on the substrate, wherein the second mask comprises a second pattern and radiating the laser beam through the second mask forms the second pattern on the first surface of the substrate.

6. The method of claim 5, wherein the second mask comprises a transmitting phase mask, a shadow mask, or combinations thereof.

7. The method of claim 1, further comprising:
disposing a transferring agent on the first surface of the substrate after the radiating step such that the transferring agent covers the pattern;
removing the transferring agent along with attached pattern from the substrate; and
transferring the pattern from the transferring agent to another substrate using a solvent.

8. The method of claim 7, wherein the transferring agent comprises polydimethylsiloxane (PDMS), polymethyl methacrylate (PMMA), or combinations thereof.

9. The method of claim 7, wherein the solvent comprises toluene, chloroform, diisopropylamine, triethylamine, tetrahydrofuran (THF), pentane, ether, or combinations thereof.

10. A method of forming a pattern on a substrate, the method comprising:
providing a highly oriented pyrolytic graphite (HOPG) substrate;
radiating a laser beam through a transmitting phase mask on the HOPG substrate, wherein the transmitting phase mask comprises a pattern and radiating the laser beam through the transmitting phase mask forms a graphene pattern on a first surface of the HOPG substrate;
disposing a transferring agent on the first surface of the HOPG substrate such that the transferring agent covers the graphene pattern;
removing the transferring agent with the attached graphene pattern from the HOPG substrate; and
transferring the graphene pattern from the transferring agent to a second substrate using a solvent.

11. The method of claim 10, further comprising curing the transferring agent prior to the removing step.

12. The method of claim 10, wherein transferring the pattern comprises dispensing the solvent onto the transferring agent to release the graphene pattern from the transferring agent.

13. The method of claim 12, further comprising removing the transferring agent from the second substrate and heating the second substrate to remove residual solvent from the second substrate.

14. The method of claim 10, wherein the graphene pattern comprises graphene ribbons.

15. The method of claim 10, wherein the second substrate comprises silicon, silicon dioxide, glass, or combinations thereof.

16. A graphene device formed according to method of claim 10.

17. A graphene device comprising a plurality of graphene features having a pre-determined shape and arranged in a pattern, wherein an edge roughness of the graphene features is less than about 1 nanometer (nm).

18. The graphene device of claim 17, wherein the edge roughness of the graphene features is about 0.6 nm to about 0.8 nm.

19. The graphene device of claim 17, wherein each of the plurality of graphene features is a single-layered feature.

20. The graphene device of claim 17 wherein the plurality of graphene features comprise graphene ribbons.

21. The graphene device of claim 17, wherein the plurality of graphene features are formed using a single-step near field interference ablation technique.

22. The graphene device of claim 21, wherein the graphene features are formed in a substantially inert atmosphere.

23. The graphene device of claim 21, wherein the plurality of graphene features comprise graphene-oxide ribbons.

24. The graphene device of claim 21, wherein the graphene device forms a transparent conducting electrode.

25. A system for forming a pattern on a substrate, comprising:
a laser source; and
a transmitting phase mask having a pattern, wherein the laser source is configured to apply a periodically modulated laser beam through the transmitting phase mask on the substrate to form the pattern on the substrate.

26. The system of claim 25, wherein the laser source comprises a Nd:YAG laser.

27. The system of claim 26, wherein the laser source is operated in a Q-switch mode to apply a single shot of laser pulse on the substrate.

28. The system of claim 25, wherein the transmitting phase mask comprises a compact disk (CD), a digital video disk (DVD), or combinations thereof.

29. The system of claim 25, further comprising a total internal reflection prism (TIR) and a lens configured to focus the laser beam onto the substrate.

30. The system of claim 29, wherein a focal length of the lens is about 30 centimeters (cm).

31. The system of claim 25, wherein the substrate comprises a polymer, a metal, a semiconductor, an insulating material, or combinations thereof.

32. The system of claim 31, wherein the substrate comprises a highly oriented pyrolytic graphite (HOPG) substrate and the pattern comprises graphene ribbons.

33. The system of claim 25, further comprising one or more additional phase masks to form a desired pattern on the substrate.
